(19) United States
(12) Patent Application Publication
(10) Pub. No.: US 2007/0122686 A1
(43) Pub. Date: May 31, 2007

(54) Cathode catalyst for fuel cell, membrane-electrode assembly for fuel cell including same and fuel cell system including same

(76) Inventors: Alexey Alexandrovichserov, Yongin-si (KR); Chan Kwak, Yongin-si (KR); Si-Hyun Lee, Yongin-si (KR)

Correspondence Address: CHRISTIE, PARKER & HALE, LLP, PO BOX 7068, PASADENA, CA, 91109-7068, US

(21) Appl. No.: 11/607,660

(22) Filed: Nov. 30, 2006

(30) Foreign Application Priority Data
Nov. 30, 2005 (KR) 10-2005-0115918

(51) Int. Cl. H01M 4/90; B01J 27/057; C01G 55/00; C01B 19/04

(52) U.S. Cl. 429/40; 423/509; 423/561.1; 502/215

(57) ABSTRACT

A cathode catalyst including Ru-Ch having a skeletal structure. The Ch includes a material selected from the group consisting of S, Se, Te, and combinations thereof. The Ru-Ch may include from about 40 to about 95 atom % of Ru, and from about 5 to about 60 atom % of Ch; or from about 50 to about 70 atom % of Ru, and from about 30 to about 50 atom % of Ch. The skeletal structure may include a plurality of ruthenium tubes having a three-dimensionally connected network, and the Ch may be connected to the ruthenium tubes. The skeletal structure of the Ru-Ch may be formed using a RuM alloy, where M is a material selected from the group consisting of Al, Mg, and combinations thereof.

### CROSS-REFERENCE TO RELATED APPLICATION

This application claims priority to and the benefit of Korean Patent Application No. 10-2005-0115918, filed in the Korean Intellectual Property Office on Nov. 30, 2005, the entire content of which is incorporated herein by reference.

### FIELD OF THE INVENTION

The present invention relates to a cathode catalyst for a fuel cell, a membrane-electrode assembly for a fuel cell, and a fuel cell system including the same.

### BACKGROUND OF THE INVENTION

A fuel cell is a power generation system for producing electrical energy through an electrochemical redox reaction of an oxidant and hydrogen in a hydrocarbon-based material such as methanol, ethanol, or natural gas.

Representative exemplary fuel cells include a polymer electrolyte membrane fuel cell (PEMFC) and a direct oxidation fuel cell (DOFC). The direct oxidation fuel cell includes a direct methanol fuel cell, which uses methanol as a fuel.

The polymer electrolyte fuel cell has a high energy density, but requires a fuel reforming processor for reforming methane or methanol, natural gas, and the like in order to produce hydrogen as the fuel gas.

By contrast, the direct oxidation fuel cell has a lower energy density than that of the polymer electrolyte fuel cell, but it does not need an additional fuel reforming processor.

In an above-mentioned fuel cell, a stack that generates electricity substantially includes several cell units (or unit cells) stacked in multiple layers, and each cell unit (or unit cell) is formed by a membrane-electrode assembly (MEA) and a separator (also referred to as a bipolar plate). The membrane-electrode assembly has an anode (also referred to as a fuel electrode or an oxidation electrode) and a cathode (also referred to as an air electrode or a reduction electrode) that are separated by an electrolyte membrane therebetween.

### SUMMARY OF THE INVENTION

Aspects of the present invention relate to a cathode catalyst having a relatively high activity for reduction of an oxidant and a relatively high selectivity, and being capable of improving performance of a membrane-electrode assembly for a fuel cell, and a membrane-electrode assembly and a fuel cell system including the same.

More specifically, an aspect of the present invention provides a cathode catalyst for a fuel cell that has a relatively large specific surface area due to a small particle size and a relatively high activity for reduction of an oxidant without being supported on a carrier. Another aspect of the present invention provides a membrane-electrode assembly for a fuel cell including the cathode catalyst. A further aspect of the present invention provides a fuel cell system including the membrane-electrode assembly for a fuel cell.

According to one embodiment of the present invention, a cathode catalyst for a fuel cell that includes Ru-Ch having a skeletal structure is provided. The Ch includes (or is) a material selected from the group consisting of S, Se, Te, and combinations thereof.

According to another embodiment of the present invention, a membrane-electrode assembly for a fuel cell including an anode and a cathode facing each other and a polymer electrolyte membrane interposed therebetween is provided. The anode includes a conductive electrode substrate and a catalyst layer formed thereon. The cathode also includes a conductive electrode substrate and a catalyst layer formed thereon. Here, the catalyst layer of the cathode includes the cathode catalyst according to an embodiment of the present invention.

According to a further embodiment of the present invention, a fuel cell system is provided. Here, the fuel cell system includes an electricity generating element, which includes a membrane-electrode assembly according to an embodiment of the present invention, and a separator positioned at either side of the membrane-electrode assembly. In addition, the fuel cell system includes a fuel supplier that supplies the electricity generating element with a fuel, and an oxidant supplier that supplies the electricity generating element with an oxidant.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic cross-sectional view showing a membrane-electrode assembly according to an embodiment of the present invention.

FIG. 2 is a schematic diagram showing a structure of a fuel cell system according to an embodiment of the present invention.

### DETAILED DESCRIPTION

In the following detailed description, certain embodiments of the present invention are shown and described, by way of illustration. As those skilled in the art would recognize, the described embodiments may be modified in various ways, all without departing from the spirit or scope of the present invention. Accordingly, the drawings and description are to be regarded as illustrative in nature, rather than restrictive.

A fuel cell is a power generation system for generating electrical energy through oxidation of a fuel and reduction of an oxidant. The oxidation of a fuel occurs at an anode, while the reduction of an oxidant occurs at a cathode.

The anode includes an anode catalyst layer for oxidizing a fuel, and the cathode includes a cathode catalyst layer for reducing an oxidant. The catalyst for the anode catalyst layer may include platinum-ruthenium, while the catalyst for the cathode catalyst layer may include platinum.

However, using platinum as a cathode catalyst has a problem in that platinum provides a relatively low activity for a reduction reaction of an oxidant. Platinum can also be depolarized by a fuel that crosses over toward a cathode through an electrolyte membrane, thereby becoming non-activated in a direct oxidation fuel cell. Therefore, there is a need for another catalyst that can be substituted for platinum.

The cathode catalyst according to one embodiment of the present invention includes Ru-Ch having a skeletal structure. The Ch includes (or is) a chalcogen material selected from the group consisting of S, Se, Te, and combinations thereof. The Ru-Ch catalyst according to one embodiment of the present invention has a relatively high activity and selectivity for an oxidant reduction reaction.

Ruthenium (Ru) (or rhodium (Rh)) is a platinum-grouped element (or a transition metal) and has a relatively high activity for a reduction reaction of an oxidant. However, oxygen in the air is easily adsorbed by Ru (or Rh) and can thereby block the active center of Ru (or Rh), resulting in deterioration of reduction of an oxidant.

Accordingly, pursuant to aspects of the present invention, S, Se, or Te is bound to Ru to block (or prevent) oxygen in the air from being bound with Ru, thereby promoting reduction of an oxidant and suppressing oxidation of a fuel. As a result, Ru-Ch has a relatively high activity and selectivity for an oxidant reduction reaction.

In the Ru-Ch, Ru is included in an amount ranging from 40 to 95 atom % and, in one embodiment, ranging from 50 to 70 atom %, and Ch is included in an amount ranging from 5 to 60 atom % and, in one embodiment, ranging from 30 to 50 atom %. When the amount of Ch is more than 60 atom %, the number of active centers decreases and therefore, activity for a reduction reaction of an oxidant significantly decreases. Whereas, when the amount of Ch is less than 5 atom %, selectivity for a reduction reaction of an oxidant decreases.

The Ru-Ch particles may be aggregated with each other, resulting in a relatively large particles. Accordingly, the Ru-Ch may need to be generally supported on a carrier. Also, the aggregated Ru-Ch has a relatively small surface area per unit mass, which is a specific surface area that results in low catalytic activity.

By contrast, the Ru-Ch cathode catalyst according to one embodiment of the present invention has a small particle size resulting in a relatively large specific surface area. Accordingly, the cathode catalyst has excellent oxidant reduction reaction without being supported on a carrier.

In one embodiment of the present invention, the Ru-Ch particles do not aggregate, and maintain a small particle size, without being supported on a carrier because the Ru-Ch cathode catalyst has a skeletal structure. The skeletal structure refers to a structure where ruthenium tubes have a three-dimensionally connected network. The ruthenium tubes are formed in a skeletal-shaped structure, and chalcogens are connected to the ruthenium tubes. In such a skeletal structure, there is a binding force between the ruthenium atoms, and as a result, a stable structure can be maintained without aggregation of small-sized particles.

The cathode catalyst can be prepared as follows.

First, a RuM alloy is prepared, where M includes a metal (or element) selected from the group consisting of Al, Mg, and combinations thereof. In the alloy, Ru is included in an amount ranging from 70 to 90 atom %. In the resulting RuM alloy, ruthenium powders and metal M powders are mixed and then reacted at a temperature ranging from 2,700 to 3,000° C.

The RuM alloy is added in a strong acidic or basic solution to remove the metal M. Ru has a skeletal structure after M is removed.

Ru of the skeletal structure is bound with Ch in a high temperature organic solvent to prepare Ru-Ch with a skeletal structure.

The present invention also provides a membrane-electrode assembly for a fuel cell including a cathode catalyst for a fuel cell.

The membrane-electrode assembly of the present invention includes a polymer electrolyte membrane with an anode and a cathode on opposite sides of the polymer electrolyte membrane. The anode includes an electrode substrate and a catalyst layer disposed on the electrode substrate, and the cathode also includes an electrode substrate and a catalyst layer disposed on the electrode substrate.

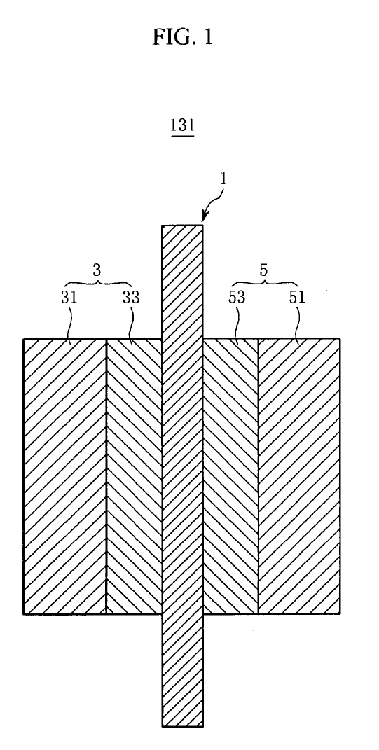

FIG. 1 is a schematic cross-sectional view of a membrane-electrode assembly 131 according to an embodiment of the present invention. Hereinafter, the membrane-electrode assembly 131 of the present invention is described in more detail with reference to FIG. 1.

The membrane-electrode assembly 131 generates electrical energy through oxidation of a fuel and reduction of an oxidant. One or several membrane-electrode assemblies are stacked adjacent to one another to form a stack.

An oxidant is reduced at a catalyst layer 53 of a cathode 5 of the membrane-electrode assembly 131, which includes a cathode catalyst that includes Ru-Ch having a skeletal structure. The Ch includes (or is) a material selected from the group consisting of S, Se, Te, and combinations thereof. The cathode catalyst can maintain a small particle size without being supported on a carrier, resulting in a relatively high activity, as well as a relatively high selectivity for an oxidant reduction reaction. Thereby the cathode catalyst improves performance of the cathode 5 and the membrane-electrode assembly 131 including the same.

A fuel is oxidized at a catalyst layer 33 of an anode 3 of the membrane-electrode assembly 131, which includes a catalyst that is capable of accelerating the oxidation of a fuel. The catalyst may be platinum-based (i.e., may be any suitable platinum-based catalyst). The platinum-based catalyst includes platinum, ruthenium, osmium, a platinum-ruthenium alloy, a platinum-osmium alloy, a platinum-palladium alloy, a platinum-M alloy, or combinations thereof, where M includes a transition element (or metal) selected from the group consisting of Ga, Ti, V, Cr, Mn, Fe, Co, Ni, Cu, Zn, Sn, Mo, W, Rh, and combinations thereof. Representative examples of the catalyst include a catalyst selected from the group consisting of Pt, Pt/Ru, Pt/W, Pt/Ni, Pt/Sn, Pt/Mo, Pt/Pd, Pt/Fe, Pt/Cr, Pt/Co, Pt/Ru/W, Pt/Ru/Mo, Pt/Ru/V, Pt/Fe/Co, Pt/Ru/Rh/Ni, Pt/Ru/Sn/W, and combinations thereof.

Such a metal catalyst may be used in a form of a metal itself (black catalyst or without a carrier) or can be used while being supported on a carrier. The carrier may include carbon such as acetylene black, denka black, activated carbon, ketjen black, and/or graphite, and/or an inorganic particulate such as alumina, silica, zirconia, and/or titania. In one embodiment, carbon is used.

The catalyst layers 33 and 53 may further include a binder resin. The binder resin may be any suitable material that is used in an electrode for a fuel cell. Non-limiting examples of the binder resin include polytetrafluoroethylene, polyvinylidene fluoride, polyvinylidene chloride, polyvinyl alcohol, cellulose acetate, poly(perfluorosulfonic acid), etc.

The electrode substrates 31 and 51 of the anode 3 and the cathode 5 provide a path for transferring reactants such as fuel and an oxidant to the catalyst layers 33 and 53. In one embodiment, the electrode substrates 31 and 51 are formed from a material such as carbon paper, carbon cloth, carbon felt, or a metal cloth (a porous film composed of metal fiber or a metal film disposed on a surface of a cloth composed of polymer fibers). However, the electrode substrate of the present invention is not limited thereto.

The polymer electrolyte membrane 1 exchanges ions by transferring the protons produced from an anode catalyst 33 to a cathode catalyst 53.

Proton conductive polymers for the polymer electrolyte membrane of the present invention may be any polymer resin having a cation exchange group at its side chain selected from the group consisting of a sulfonic acid group, a carboxylic acid group, a phosphoric acid group, a phosphonic acid group, and derivatives thereof.

Non-limiting examples of the polymer resin include a proton conductive polymer selected from the group consisting of fluoro-based polymers, benzimidazole-based polymers, polyimide-based polymers, polyetherimide-based polymers, polyphenylenesulfide-based polymers polysulfone-based polymers, polyethersulfone-based polymers, polyetherketone-based polymers, polyether-etherketone-based polymers, and polyphenylquinoxaline-based polymers. In one embodiment of the present invention, the proton conductive polymer includes a polymer selected from the group consisting of poly(perfluorosulfonic acid), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), or poly (2,5-benzimidazole). In one embodiment, the polymer electrolyte membrane has a thickness ranging from 10 to 200 μm.

According to an embodiment of the present invention, a fuel cell system including the above membrane-electrode assembly is provided. The fuel cell system includes one or more electricity generating elements, a fuel supplier, and an oxidant supplier.

The electricity generating element includes a membrane-electrode assembly, and separators (bipolar plates) positioned at both sides of the membrane-electrode assembly. The electricity generating element generates electricity through oxidation of a fuel and reduction of an oxidant.

The fuel supplier supplies the electricity generating element with a fuel including hydrogen, and the oxidant supplier supplies the electricity generating element with an oxidant. The fuel includes liquid or gaseous hydrogen, or a hydrocarbon-based fuel such as methanol, ethanol, propanol, butanol, or natural gas. The oxidant generally includes oxygen or air. The fuel and oxidant of the present invention are not limited thereto.

The fuel cell system may be applied to a polymer electrolyte fuel cell (PEMFC), and/or a direct oxidation fuel cell (DOFC). According to one embodiment of the present invention, since a cathode catalyst has a relatively high selectivity for reduction of oxygen, it can be more effectively used for a direct oxidation fuel cell having a fuel crossover problem and most effectively for a direct methanol fuel cell (DMFC).

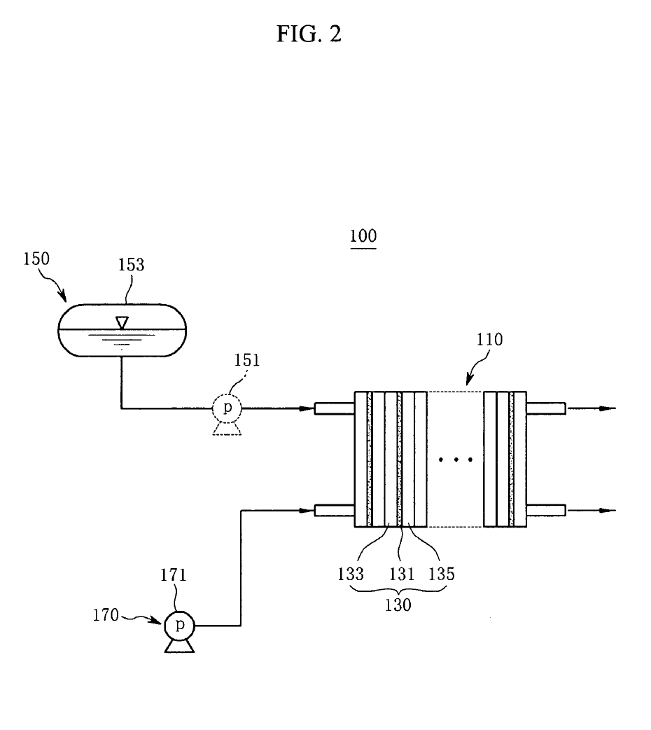

FIG. 2 shows a schematic structure of a fuel cell system 100 that will be described in more detail with reference to FIG. 2, as follows. FIG. 2 illustrates a fuel cell system wherein a fuel and an oxidant are provided to the electricity generating element 130 through pumps 151 and 171, but the present invention is not limited to such structures. The fuel cell system of the present invention alternatively may include a structure wherein a fuel and an oxidant are provided by diffusion.

A fuel cell system 100 includes a stack 110 composed of one or more electricity generating elements 130 for generating electrical energy through an electrochemical reaction of a fuel and an oxidant. In addition, the fuel cell system includes a fuel supplier 150 for supplying the fuel to the one or more electricity generating elements 130, and an oxidant supplier 170 for supplying the oxidant to the one or more electricity generating elements 130.

In addition, the fuel supplier 150 is equipped with a tank 153 that stores fuel, and a pump 151 that is connected therewith. The fuel pump 151 supplies fuel stored in the tank 153 to the stack 110.

The oxidant supplier 170, which supplies the one or more electricity generating elements 130 of the stack 110 with the oxidant, is equipped with at least one pump 171 for supplying the oxidant to the stack 110.

The electricity generating element 130 includes a membrane-electrode assembly 131 that oxidizes hydrogen (or a fuel) and reduces an oxidant, and separators 133 and 135 that are respectively positioned at opposite sides of the membrane-electrode assembly 131 and supply hydrogen (or the fuel) and the oxidant, respectively.

The following examples illustrate the present invention in more detail. However, the present invention is not limited by these examples.

### EXAMPLE 1

10 g of ruthenium and 3 g of aluminum were mixed and heat-treated at 2,700° C. to prepare a RuAl alloy. 13 g of the RuAl alloy prepared above and 500 mL of 10M NaOH were mixed to remove Al to prepare Ru having a skeletal structure. 5 g of Ru having the skeletal structure was added to a benzene solvent at 200° C., and then 0.1 g of Se powders was added, followed by refluxing and drying. Then the resultant was heat-treated at 250° C. under a hydrogen atmosphere for 3 hours to prepare a cathode catalyst.

### COMPARATIVE EXAMPLE 1

0.6 g of ruthenium carbonyl was dissolved in 150 ml of benzene. 0.01 g of selenium powder and 1 g of ketjen black were added to the prepared solution, and thereafter, agitated for 24 hours while refluxing them at 120° C. Then, the resultant was dried at 80° C. for 12 hours after washing and then heat-treated at 250° C. for 3 hours under a hydrogen atmosphere to prepare a cathode catalyst.

Next, an oxygen gas was bubbled into a sulfuric acid solution in 0.5M concentration to prepare an oxygen-saturated sulfuric acid solution. The catalyst of Example 1 and the catalyst of Comparative Example 1 (Ru—Se supported on a carbon) were respectively loaded on a glassy carbon with 3.78×10⁻³ mg to prepare the working electrodes. Then, a platinum mesh was prepared as the counter electrode. These electrodes were then placed in the sulfuric acid solution, and current densities for Example 1 and Comparative Example 1 were then determined at 0.7V. The results are provided in the following Table 1.

TABLE 1

| | Current Density (mA/cm² (at 0.7 V)) |
|---|---|
| Example 1 | 1.52 |
| Comparative Example 1 | 0.51 |

As shown in Table 1, the catalyst of Example 1 has a higher catalyst activity than that of Comparative Example 1.

In view of the foregoing, a cathode catalyst of an embodiment of the present invention has a relatively large specific surface area due to being composed of small-sized particles, and as a result, has a relatively high activity without being supported on a carrier.

While the invention has been described in connection with certain exemplary embodiments, it is to be understood by those skilled in the art that the invention is not limited to the disclosed embodiments, but, on the contrary, is intended to cover various modifications included within the spirit and scope of the appended claims and equivalents thereof.

What is claimed is:

1. A cathode catalyst for a fuel cell, the cathode catalyst comprising Ru-Ch having a skeletal structure,
wherein Ch includes a material selected from the group consisting of S, Se, Te, and combinations thereof.

2. The cathode catalyst of claim 1, wherein the Ru-Ch comprises from about 40 to about 95 atom % of Ru, and from about 5 to about 60 atom % of Ch.

3. The cathode catalyst of claim 2, wherein the Ru-Ch comprises from about 50 to about 70 atom % of Ru, and from about 30 to about 50 atom % of Ch.

4. The cathode catalyst of claim 1, wherein Ch is Se.

5. The cathode catalyst of claim 1, wherein the skeletal structure comprises a plurality of ruthenium tubes having a three-dimensionally connected network.

6. The cathode catalyst of claim 5, wherein the Ch is connected to the ruthenium tubes.

7. The cathode catalyst of claim 1, wherein the skeletal structure of the Ru-Ch is formed using a RuM alloy, and wherein M includes a material selected from the group consisting of Al, Mg, and combinations thereof.

8. A membrane-electrode assembly for a fuel cell, the membrane-electrode assembly comprising a polymer electrolyte membrane with an anode and a cathode on opposite sides of the polymer electrolyte membrane, wherein the anode comprises a conductive electrode substrate and a catalyst layer disposed on the electrode substrate, and the cathode comprises a conductive electrode substrate and a catalyst layer disposed on the electrode substrate, the catalyst layer of the cathode comprising Ru-Ch having a skeletal structure, where Ch is a material selected from the group consisting of S, Se, Te, and combinations thereof.

9. The cathode catalyst of claim 8, wherein the polymer electrolyte membrane comprises a polymer resin having a cation exchange group at its side chain selected from the group consisting of a sulfonic acid group, a carboxylic acid group, a phosphoric acid group, a phosphonic acid group, and derivatives thereof.

10. The membrane-electrode assembly of claim 9, wherein the polymer resin comprises a proton conductive polymer selected from the group consisting of fluoro-based polymers, benzimidazole-based polymers, polyimide-based polymers, polyetherimide-based polymers, polyphenylenesulfide-based polymers, polysulfone-based polymers, polyethersulfone-based polymers, polyetherketone-based polymers, polyether-etherketone-based polymers, polyphenylquinoxaline-based polymers, and combinations thereof.

11. The membrane-electrode assembly of claim 10, wherein the polymer resin comprises a material selected from the group consisting of poly(perfluorosulfonic acid), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), poly (2,5-benzimidazole), and combinations thereof.

12. The membrane-electrode assembly of claim 8, wherein the catalyst layer of the anode comprises a material selected from the group consisting of platinum, ruthenium, osmium, a platinum-ruthenium alloy, a platinum-osmium alloy, a platinum-palladium alloy, a platinum-M alloy, and combinations thereof, and wherein M comprises a transition metal selected from the group consisting of Ga, Ti, V, Cr, Mn, Fe, Co, Ni, Cu, Zn, Sn, Mo, W, Rh, and combinations thereof.

13. The membrane-electrode assembly of claim 12, wherein the catalyst in the anode is supported on a carrier, and wherein the carrier includes a material selected from the group consisting of acetylene black, denka black, activated carbon, ketjen black, graphite, alumina, silica, titania, zirconia, and combinations thereof.

14. The membrane-electrode assembly of claim 8, wherein at least one of the catalyst layer of the anode or the catalyst layer of the cathode comprises a binder resin selected from the group consisting of polytetrafluoroethylene, polyvinylidene fluoride, polyvinylidene chloride, polyvinyl alcohol, cellulose acetate, poly(perfluorosulfonic acid), and combinations thereof.

15. The membrane-electrode assembly of claim 8, wherein at least one of the electrode substrate of the anode or the electrode substrate of the cathode is selected from the group consisting of a carbon paper, a carbon cloth, a carbon felt, a metal cloth, and combinations thereof.

16. A fuel cell system comprising an electricity generating element, a fuel supplier adapted to supply the electricity generating element with a fuel, and an oxidant supplier adapted to supply the electricity generating element with an oxidant, wherein the electricity generating element comprises a membrane-electrode assembly comprising a polymer electrolyte membrane with an anode and a cathode on opposite sides of the polymer electrolyte membrane, wherein the anode comprises a conductive electrode substrate and a catalyst layer disposed on the electrode substrate, and the cathode comprises a conductive electrode substrate and a catalyst layer disposed on the electrode substrate, wherein the catalyst layer of the cathode comprises Ru-Ch having a skeletal structure, where Ch is a material selected from the group consisting of S, Se, Te, and combinations thereof.

17. The fuel cell system of claim 16, wherein the fuel cell system is for a polymer electrolyte membrane fuel cell.

18. The fuel cell system of claim 16, wherein the fuel cell system is for a direct oxidation fuel cell.

19. The fuel cell system of claim 18, wherein the direct oxidation fuel cell is a direct methanol fuel cell.

20. The fuel cell system of claim 16, further comprising a separator positioned at either side of the membrane-electrode assembly.
